(19) United States
(12) Patent Application Publication
(10) Pub. No.: US 2021/0108013 A1
(43) Pub. Date: Apr. 15, 2021

(54) WATER-SOLUBLE COPOLYMERS

(71) Applicant: WACKER CHEMIE AG, Munich (DE)

(72) Inventor: Abdulmajid HASHEMZADEH, Burghausen (DE)

(73) Assignee: WACKER CHEMIE AG, Munich (DE)

(21) Appl. No.: 16/977,924

(22) PCT Filed: Jul. 4, 2018
(86) PCT No.: PCT/EP2018/068154

§ 371 Date: Sep. 3, 2020

(51) Int. Cl. C08F 228/02; C08F 220/56; C08F 265/06; C08J 3/05; C09J 133/08; C09J 133/26; C09J 141/00; C09D 5/00; C09D 133/08; C09D 133/26; C09D 141/00; B01J 13/00; C09K 3/22; D21H 21/50; D21H 17/37

(52) U.S. Cl. CPC C08F 228/02; C08J 2333/26; C08F 265/06; C08J 3/05; C09J 133/08; C09J 133/26; C09J 141/00; C09D 5/002; C09D 133/08; C09D 133/26; C09D 141/00; B01J 13/0034; B01J 13/0021; C09K 3/22; D21H 21/50; D21H 17/375; C08J 2341/00; C08J 2333/08; C08F 220/56

(57) ABSTRACT

Water-soluble copolymers based on
a) 50 to 97% by weight of one or more non-ionic, ethylenically unsaturated monomers containing amide groups,
b) 0.1 to 10% by weight of one or more ethylenically unsaturated monomers containing silane groups
c) 1 to 30% by weight of one or more ionic, ethylenically unsaturated monomers and optionally one or more further ethylenically unsaturated monomers, are useful as protective colloids for inorganic particle and water-insoluble polymer particle dispersions. wherein the figures in % by weight add up to 100% by weight.

### CROSS REFERENCE TO RELATED APPLICATIONS

This application is the U.S. National Phase of PCT Appln. No. PCT/EP2018/068154 filed Jul. 4, 2018, the disclosure of which is incorporated in its entirety by reference herein.

### BACKGROUND OF THE INVENTION

### 1. Field of the Invention

The present invention relates to water-soluble copolymers based on non-ionic monomers containing amide groups and ionic monomers, processes for the production thereof and use thereof, for example as protective colloids for aqueous polymer dispersions or for powders redispersible in water.

### 2. Description of the Related Art

Water-soluble polymers are used, for example, as protective colloids for stabilizing aqueous dispersions of water-insoluble polymers or for producing polymer powders redispersible in water. Such polymer dispersions or polymer powders may be used, for example, in construction chemical products. Common protective colloids are polyvinyl alcohol, polyvinylpyrrolidone, cellulose or starch, as described in EP-A 133899, WO-A 84/00369 or EP-B 62106. Such protective colloids must be used sometimes in considerable quantities for an adequate stabilizing effect, which can be associated with disadvantages: by adding protective colloid the binder content of the dispersion is reduced, it may result in rheological disadvantages, and lastly the addition of protective colloids may make the polymer films produced with the dispersion sensitive to water. These problems are particularly apparent in the case of protective colloids for water-insoluble copolymers based on (meth)acrylic acid esters and/or aromatics such as styrene. In addition, protective colloids are relatively expensive.

To improve the water-resistance of corresponding polymer films, EP-A 727441 recommends using water-soluble protective colloids based on 5 to 50% acid(anhydride)-functional comonomers, 0.1 to 80% long-chain (meth)acrylic acid esters and up to 94.9% of water-insoluble principal monomers such as (meth)acrylates or vinyl esters. A disadvantage is that these protective colloids are produced by polymerization in organic solvents and the solvent has to be laboriously removed by distillation. DE-A 2618898 describes protective colloids based on hydrophobic monomer units, methyl methacrylate for example, and hydrophilic monomer units, ethylenically unsaturated sulfonate comonomers for example, production thereof also being carried out by polymerization in organic solvents.

As drying agents for spray-drying protective colloid-stabilized polymer dispersions, EP-A 629650 recommends copolymers of sulfonic acid-functional comonomers and water-insoluble comonomers and EP-A 671435 recommends copolymers of alkyl acrylates and sulfonate- or carboxylate-substituted monomers.

Crosslinkable protective colloids with sulfonate-containing, N-methylol-containing and hydrophobic monomer units are known from DE-A 19608911. A disadvantage is that such protective colloid-stabilized polymers, when used in acidic environments or under thermal stress, crosslink and therefore become brittle. This runs contrary to the elastic properties demanded in many applications (sealing slurries, sealing compositions, crack-bridging paints).

To improve the water-resistance of polymer-modified coatings or construction products, WO-A 98/49205 recommends the use of protective colloids based on 5 to 95% by weight of monomers containing sulfonic acid or sulfonate groups, 5 to 95% by weight of non-crosslinkable water-soluble monomers and 0 to 5% by weight of hydrophobic monomers. U.S. Pat. No. 7,968,642 recommends low molecular weight or low viscosity polyacrylamides as protective colloids for redispersible polymer powders. EP-B 206814 describes the use of terpolymers of (meth)acrylic acid, sulfonate-functional monomers and vinyl esters for stabilizing aqueous systems, such as cooling water or boiler water, which comprise dissolved or suspended solids.

Against this background, the object consisted of providing water-soluble polymers as protective colloids for polymers in the form of aqueous dispersions or powders redispersible in water, with which the problems mentioned above can be confronted.

### SUMMARY OF THE INVENTION

The invention relates to water-soluble copolymers based on
a) 50 to 97% by weight of one or more non-ionic, ethylenically unsaturated monomers containing amide groups,
b) 0.1 to 10% by weight of one or more ethylenically unsaturated monomers containing silane groups,
c) 1 to 30% by weight of one or more ionic, ethylenically unsaturated monomers and
   optionally further ethylenically unsaturated monomers, wherein the figures in % by weight add up to 100% by weight.

### DETAILED DESCRIPTION OF THE PREFERRED EMBODIMENTS

Examples of non-ionic, ethylenically unsaturated monomers containing amide groups a) are ethylenically unsaturated compounds comprising amide groups (—CONH₂). The monomers a) therefore generally bear no anionic or cationic groups such as acid or ammonium groups. The monomers a) preferably bear no silane groups and no ionic groups, especially no anionic or cationic groups.

Preferred monomers a) are (meth)acrylamide, vinylpyrrolidone and diacetone acrylamide. Particular preference is given to methacrylamide and especially acrylamide.

The monomers a) can also be crosslinking monomers such as, for example, acrylamides comprising N-methylol groups (—NH—CH₂OH) or etherified derivatives thereof (—NH—CH₂OR where R═C₁- to C₆-alkyl), particularly N-methylolacrylamide (NMA), N-methylolmethacrylamide (NMMA), N-(isobutoxymethyl)acrylamide (IBMA), N-(isobutoxymethyl)methacrylamide, N-(n-butoxymethyl)acrylamide (NBMA). Preferred crosslinking monomers a) are N-methylolacrylamide and N-(isobutoxymethyl)acrylamide.

The monomers a) are preferably non-crosslinking monomers to the extent of ≥50% by weight, more preferably ≥80% by weight and most preferably ≥95% by weight, based on the total weight of the monomers a). The fraction of crosslinking monomers a) is preferably ≤3% by weight and most preferably ≤1% by weight, based on the total weight of the water-soluble copolymers. Most-preferred water-soluble copolymers do not comprise any units of crosslinking monomers a).

Preferably, the water-soluble copolymers are based to an extent of 60 to 95% by weight, more preferably 70 to 94% by weight and most preferably 80 to 92% by weight on monomers a), based on the total weight of the water-soluble copolymers.

Ethylenically unsaturated monomers containing silane groups b) are, for example, ethylenically unsaturated silicon compounds, of the formula R¹SiR²₀₋₂(OR³)₁₋₃, where R¹ has the definition CH₂═CR⁴-(CH₂)₀₋₁ or CH₂═CR⁴CO₂(CH₂)₁₋₃, R² has the definition C₁- to C₃-alkyl radical, C₁- to C₃-alkoxy radical or halogen, preferably Cl or Br, R³ is an unbranched or branched, optionally substituted alkyl radical having 1 to 12 carbon atoms, preferably 1 to 3 carbon atoms, or is an acyl radical having 2 to 12 carbon atoms, where R³ can optionally be interrupted by an ether group, and R⁴ is H or CH₃.

Preferred monomers containing silane groups b) are γ-acryl-or γ-methacryloxypropyltri(alkoxy)silanes, α-methacryloxymethyltri(alkoxy)silanes, γ-methacryloxypropylmethyldi(alkoxy)silanes; vinylsilanes such as vinylalkyldi(alkoxy)silanes and vinyltri(alkoxy)silanes, wherein methoxy, ethoxy, methoxyethylene, ethoxyethylene, methoxypropylene glycol ether or ethoxypropylene glycol ether radicals may be used as alkoxy groups for example.

Examples of preferred monomers containing silane groups b) are 3-methacryloxypropyltrimethoxysilane, 3-methacryloxypropylmethyldimethoxysilane, vinyltrimethoxysilane, vinylmethyldimethoxysilane, vinyltriethoxysilane, vinylmethyldiethoxysilane, vinyltripropoxysilane, vinyltriisopropoxysilane, vinyltris-(1-methoxy)isopropoxysilane, vinyltributoxysilane, vinyltriacetoxysilane, methacryloxymethyltrimethoxysilane, 3-methacryloxypropyltris(2-methoxyethoxy)silane, vinyltrichorosilane, vinylmethyldichlorosilane, vinyltris-(2-methoxyethoxy)silane, trisacetoxyvinylsilane, allylvinyltrimethoxysilane, allyltriacetoxysilane, vinyldimethylmethoxysilane, vinyldimethylethoxysilane, vinylmethyldiacetoxysilane, vinyldimethylacetoxysilane, vinylisobutyldimethoxysilane, vinyltriisopropyloxysilane, vinyltributoxysilane, vinyltrihexyloxysilane, vinylmethoxydihexoxysilane, vinyltrioctyloxysilane, vinyldimethoxyoctyloxysilane, vinylmethoxydioctyloxysilane, vinylmethoxydilauryloxysilane, vinyldimethoxylauryloxysilane and polyethylene glycol-modified vinylsilanes.

Most preferred as monomers containing silane groups b) are vinyltrimethoxysilane, vinylmethyldimethoxysilane, vinyltriethoxysilane, vinylmethyldiethoxysilane, vinyltris-(1-methoxy)isopropoxysilane, methacryloxypropyltris(2-methoxyethoxy)silane, 3-methacryloxypropyltrimethoxysilane, 3-methacryloxypropylmethyldimethoxysilane and methacryloxymethyltrimethoxysilane and mixtures thereof.

Suitable monomers containing silane groups b) are also (meth)acrylamides comprising silane groups, of the general formula CH₂═CR⁵—CO—NR⁶—R⁷—SiR⁸ₙ—(R⁹)₃₋ₘ, where n=0 to 4, m=0 to 2, R⁵ is either H or a methyl group, R⁶ is H or is an alkyl group having 1 to 5 carbon atoms; R⁷ is an alkylene group having 1 to 5 carbon atoms or a bivalent organic group in which the carbon chain is interrupted by an O or N atom, R⁸ is an alkyl group having 1 to 5 carbon atoms, R⁹ is an alkoxy group having 1 to 40 carbon atoms, which may be substituted by further heterocycles. In monomers in which 2 or more R⁵ or R⁹ groups occur, these may be identical or different.

Examples of such (meth)acrylamidoalkylsilanes are: 3-(meth)acrylamidopropyltrimethoxysilane, 3-(meth)acrylamidopropyltriethoxysilane, 3-(meth)acrylamidopropyltri(β-methoxyethoxy)silane, 2-(meth)acrylamido-2-methylpropyltrimethoxysilane, 2-(meth)acrylamido-2-methylethyltrimethoxysilane, N-(2-(meth)acrylamidoethyl)aminopropyltrimethoxysilane, 3-(meth)acrylamidopropyltriacetoxysilane, 2-(meth)acrylamidoethyltrimethoxysilane, 1-(meth)acrylamidomethyltrimethoxysilane, 3-(meth)acrylamidopropylmethyldimethoxysilane, 3-(meth)acrylamidopropyldimethylmethoxysilane, 3-(N-methyl(meth)acrylamido)propyltrimethoxysilane, 3-((meth)acrylamidomethoxy)-3-hydroxypropyltrimethoxysilane, 3-((meth)acrylamidomethoxy)propyltrimethoxysilane, N,N-dimethyl-N-trimethoxysilylpropyl-3-(meth)acrylamidopropylammonium chloride and N-N-dimethyl-N-trimethoxysilylpropyl-2-(meth)acrylamido-2-methylpropylammonium chloride.

Preferably, the water-soluble copolymers are based to an extent of 0.2 to 7% by weight, more preferably 0.3 to 5% by weight and most preferably 0.5 to 3% by weight on monomers b), based on the total weight of the water-soluble polymers.

The ionic, ethylenically unsaturated monomers c) can be, for example, anionic ethylenically unsaturated monomers or cationic ethylenically unsaturated monomers.

Ethylenically unsaturated anionic monomers c) are ethylenically unsaturated monomers additionally bearing, for example, a carboxylic acid, sulfonic acid, sulfate or phosphonic acid group. Ethylenically unsaturated carboxylic acids can be, for example, mono- or dicarboxylic acids, preferably acrylic acid, methacrylic acid, itaconic acid, fumaric acid, maleic acid, mono- and diesters of fumaric acid and maleic acid such as the diethyl and diisopropyl esters. Examples of ethylenically unsaturated sulfonic acids are vinylsulfonic acid, 2-acrylamido-2-methylpropanesulfonic acid (AMPS), styrenesulfonic acid, sulfoalkyl (meth)acrylates, sulfoalkyl itaconates, preferably in each case with a C₁- to C₆-alkyl radical, vinylsulfonic acid. Particular preference is given to 2-acrylamido-2-methylpropanesulfonic acid (AMPS), styrenesulfonic acid, sulfopropyl acrylate, sulfopropyl itaconate, vinylsulfonic acid.

Particularly preferred monomers c) are acrylic acid, methacrylic acid and vinylsulfonic acid.

The anionic monomers c) can also be in the form of their salts, for example their alkali metal, alkaline earth metal or ammonium salts, preferably sodium, potassium, calcium or ammonium salts.

Examples of cationic monomers c) are diallyldiethylammonium chloride (DADEAC), (3-methacryloxy)propyltrimethylammonium chloride (MPTAC),(3-methacryloxy)ethyltrimethylammonium chloride (METAC), (3-methacrylamido)propyltrimethylammonium chloride (MAPTAC), trimethyl-3-(1-acrylamido-1,1-dimethylpropyl)ammonium chloride, trimethyl-3-(1-acrylamido-1,1-dimethylbutyl)ammonium chloride, dimethylacrylamidopropyl-4-trimethylammonium butenyl-2-ammonium chloride, 2-(acrylamidomethoxy)ethyltrimethylammonium chloride and especially diallyldimethylammonium chloride (DADMAC).

Preferred cationic monomers c) are diallyldimethylammonium chloride (DADMAC), diallyldiethylammonium chloride (DADEAC), (3-methacryloxy)propyltrimethylammonium chloride (MPTAC), (3-methacryloxy)ethyltrimethylammonium chloride (METAC) and (3-methacrylamido)propyltrimethylammonium chloride (MAPTAC).

Preferably, the water-soluble copolymers are based to an extent of 3 to 25αby weight, more preferably 5 to 20% by weight and most preferably 7 to 15% by weight on monomers c), based on the total weight of the water-soluble copolymers.

Optionally, the water-soluble copolymers may additionally be based on one or more hydrophobic, ethylenically unsaturated monomers d). The monomers d) are preferably soluble in water to an extent of less than 2% by weight at 23° C.

Hydrophobic, ethylenically unsaturated monomers d) are preferably selected from the group comprising vinyl esters, (meth)acrylic acid esters, vinyl aromatics, olefins, 1,3-dienes and vinyl halides.

Suitable vinyl esters are, for example, those of carboxylic acids having 1 to 20 carbon atoms, especially 2 to 15 carbon atoms, such as vinyl acetate, vinyl propionate, vinyl butyrate, vinyl 2-ethylhexanoate, vinyl laurate, 1-methylvinyl acetate, vinyl pivalate and vinyl esters of a-branched monocarboxylic acids having 9 to 11 carbon atoms.

Suitable monomers from the group of esters of acrylic acid or methacrylic acid are, for example, esters of unbranched or branched alcohols having 1 to 15 carbon atoms, such as methyl acrylate, methyl methacrylate, ethyl acrylate, ethyl methacrylate, propyl acrylate, propyl methacrylate, n-butyl acrylate, n-butyl methacrylate, 2-ethylhexyl acrylate.

Examples of vinyl aromatics are styrene, methylstyrene and vinyltoluene. An example of vinyl halide is vinyl chloride.

Examples of olefins are ethylene and propylene. Examples of dienes are 1,3-butadiene and isoprene.

Preferably, the water-soluble copolymers are based to an extent of ≤10% by weight, more preferably ≤5% by weight and most preferably ≤1% by weight on monomers d), based on the total weight of the water-soluble copolymers. Most-preferred water-soluble copolymers do not comprise any units of monomers d).

Optionally, one or more ethylenically unsaturated auxiliary monomers e) can be additionally copolymerized. Examples of auxiliary monomers e) are ethylenically unsaturated carbonitriles, preferably acrylonitrile and acetylacetoxy-ethyl acrylate or methacrylate. Auxiliary monomers e) may also be ethylenically unsaturated, crosslinking monomers e), such as pre-crosslinking or post-crosslinking monomers e). Examples of pre-crosslinking monomers e) are polyethylenically unsaturated monomers, for example divinyl adipate, diallyl maleate, allyl methacrylate, triallyl isocyanurate or triallyl cyanurate. Example of post-crosslinking monomers e) are epoxy-functional monomers, such as glycidyl methacrylate and glycidyl acrylate. Mention may also be made of monomers having hydroxyl groups, such as hydroxyalkyl methacrylates and acrylates, especially hydroxyethyl, hydroxypropyl or hydroxybutyl acrylate or methacrylate. The auxiliary monomers e), especially crosslinking monomers e), are generally different from the aforementioned monomers a) to d) or a) to c), especially different also from the aforementioned crosslinking monomers a).

Preferably, the water-soluble copolymers are based to the extent of 0 to 20% by weight, more preferably 0.5 to 10% by weight and most preferably 1 to 5% by weight on auxiliary monomers e), based on the total weight of the water-soluble copolymers.

Particularly preferable water-soluble copolymers are based on 60 to 95% by weight, especially 70 to 94% by weight of (meth)acrylamide; 0.2 to 7% by weight, especially 0.3 to 5% by weight of one or more ethylenically unsaturated monomers containing silane groups and selected from the group comprising vinyltrimethoxysilane, vinylmethyldimethoxysilane, vinyltriethoxysilane, vinylmethyldiethoxysilane, vinyltris-(1-methoxy)-isopropoxysilane, methacryloxypropyltris(2-methoxyethoxy)silane, 3-methacryloxypropyltrimethoxysilane, 3-methacryloxypropylmethyldimethoxysilane and methacryloxymethyltrimethoxysilane; 3 to 25% by weight, especially 5 to 15% by weight of one or more anionic monomers c) selected from the group comprising acrylic acid, methacrylic acid and vinylsulfonic acid or one or more cationic monomers c) selected from the group comprising diallyldimethylammonium chloride (DADMAC), diallyldiethylammonium chloride (DADEAC), (3-methacryloxy)propyltrimethylammonium chloride (MPTAC), (3-methacryloxy)ethyltrimethylammonium chloride (METAC) and (3-methacrylamido)propyltrimethylammonium chloride (MAPTAC); wherein the water-soluble copolymers optionally additionally may comprise hydrophobic, ethylenically unsaturated monomers d) and/or auxiliary monomers e), preferably in the amounts specified; wherein the figures in % by weight add up to 100% by weight.

The water-soluble copolymers preferably have a solubility in water of at least 10% by weight at 23° C.

Aqueous solutions with a 20% solids content of water-soluble copolymers preferably have a viscosity of 10 to 10,000 mPas, more preferably 50 to 5000 mPas, and most preferably 100 to 1000 mPas. The viscosity is determined using a Brookfield viscometer (using spindle 1, at 25° C. and 20 rpm).

The invention further relates to processes for producing the water-soluble copolymers according to the invention by free-radically initiated polymerization, preferably in aqueous solvent.

The water-soluble copolymers are preferably produced by the solution polymerization process.

The aqueous solvents may optionally comprise one or more organic solvents. Organic solvents are preferably water-soluble organic solvents, preferably alcohols, especially glycols, polyethylene glycol or aliphatic alcohols having 1 to 6 carbon atoms; ketones, especially acetone or methyl ethyl ketone; esters, especially methyl acetate, ethyl acetate, propyl acetate or butyl acetate; or ethers. Most-preferred organic solvents are methanol, isopropanol, methyl acetate, ethyl acetate and butyl acetate. The aqueous solvents preferably comprise ≤20% by weight, more preferably ≤10% by weight and most preferably ≤5% by weight of organic solvent, based on the total weight of the aqueous solvents. Most preferably, the aqueous solvents do not comprise any organic solvents.

The solution polymerization can be initiated using common redox-initiator combinations. Monomer conversion can be controlled by the metered addition of initiator. The initiators are generally metered in overall such that continuous polymerization is ensured. Examples of suitable oxidation initiators are sodium, potassium and ammonium salts of peroxodisulfuric acid, hydrogen peroxide, t-butyl peroxide, t-butyl hydroperoxide, potassium peroxodiphosphate, tert-butyl peroxopivalate, cumene hydroperoxide, azobisisobutyronitrile.

Preference is given to sodium, potassium and ammonium salts of peroxodisulfuric acid and hydrogen peroxide. The initiators specified are generally used in an amount from 0.01 to 2.0% by weight, based on the total weight of the monomers. Suitable reducing agents are sulfites and bisulfites of alkali metals and of ammonium, sodium sulfite for example, derivatives of sulfoxylic acid such as zinc formaldehyde sulfoxylate or alkali metal formaldehyde sulfoxylates, for example sodium hydroxymethanesulfinate (Brüggolit) and (iso)ascorbic acid. Preference is given to sodium hydroxymethanesulfinate and (iso)ascorbic acid. The amount of reducing agent is preferably 0.015 to 3% by weight, based on the total weight of the monomers. The oxidizing agents specified, especially the salts of peroxodisulfuric acid, can also be used solely as thermal initiators.

The polymerization temperature is preferably between 40° C. and 100° C., more preferably between 60° C. and 90° C. Copolymerization of gaseous comonomers such as ethylene, 1,3-butadiene or vinyl chloride may also be operated under pressure, generally between 5 bar and 100 bar.

To control the molecular weight during the solution polymerization process, regulating substances may be used. If such chain transfer agents to are used, these are typically used in amounts between 0.01, to 5.0% by weight, based on the monomers to be polymerized, and, for example, are metered in separately or else pre-mixed with reaction components. Examples of such substances are n-dodecylmercaptan, tert-dodecylmercaptan, mercaptopropionic acid, methyl mercaptopropionate, isopropanol and acetaldehyde. Preferably, no regulating substances are used.

The solution polymerization process can also be carried out in the presence of emulsifiers or protective colloids. Preferred amounts of emulsifiers and protective colloids are up to 10% by weight, especially 0.1 to 10% by weight, based on the total weight of the monomers. Particular preference is given to polymerization in the absence of emulsifiers and/or especially in the absence of protective colloids.

Examples of emulsifiers are anionic, cationic or non-ionic emulsifiers, such as anionic surfactants, especially alkyl sulfates, alkyl or alkylaryl ether sulfates, alkyl or alkylaryl sulfonates, sulfosuccinic acid (mono-)esters, or non-ionic surfactants such as alkyl polyglycol ethers or alkylaryl polyglycol ethers having 8 to 40 ethylene oxide units. Examples of protective colloids are polyvinyl alcohols such as partially hydrolyzed polyvinyl alcohols, cellulose ethers such as methyl cellulose, methylhydroxypropyl cellulose, hydroxyethyl cellulose, carboxymethyl celluloses.

When carrying out the solution polymerization processes, the polymerization is generally carried out up to a solids content of 10 to 70% by weight, preferably up to a solids content of 15 to 60% by weight.

After completion of the polymerization, residual monomer removal can be effected by post-polymerization using known methods, for example by redox catalyst-initiated post-polymerization. Volatile residual monomers can also be removed by distillation or stripping methods, preferably under reduced pressure, and optionally with passing through or passing over of inert entraining gases such as air, nitrogen or steam.

To convert the water-soluble copolymers to water-soluble polymer powders, aqueous solutions of the water-soluble copolymers are generally dried, for example by fluidized-bed drying, roller drying, freeze-drying or spray drying. The solutions are preferably spray dried. Preferably, no drying aids, in particular no protective colloids such as polyvinyl alcohols, are added to the solutions to be dried. Spray drying can be effected with customary spray drying systems, in which the atomization can be carried out by means of one-, two- or multi-fluid nozzles or using a rotating disk. The exit temperature is generally selected in the range of 45° C. to 120° C., preferably 60° C. to 90° C., depending on the system or desired degree of drying.

During atomization, a content of up to 1.5% by weight of anti-foaming agent, based on the water-soluble copolymers, has often proven to be favorable. To increase the shelf-life by improving the blocking stability, the powder obtained can be provided with an anti-blocking agent (anti-caking agent), preferably up to 30% by weight, based on the total weight of the water-soluble copolymers. Examples of anti-blocking agents are Ca or Mg carbonate, talc, gypsum, silica, kaolins, silicates having particle sizes preferably in the range of 10 nm to 10 μm.

The viscosity of the feed to be atomized is adjusted via the solids content such that a value of <500 mPas (Brookfield viscosity at 20 revolutions and 23° C.), preferably <250 mPas, is obtained. The solids content of the dispersion to be atomized is generally >35%, preferably >40%.

To improve the performance properties further additives may be added during atomiztion. Further constituents of polymer powder compositions present in preferred embodiments are, for example, pigments, fillers, foam stabilizers, hydrophobizing agents.

The water-soluble copolymers produced by the process according to the invention are therefore preferably in the form of polymer powders soluble in water and more preferably in the form of aqueous solutions. The aqueous solutions are preferably clear, but optionally may also be slightly cloudy, but are generally not in the form of dispersions. For instance, aqueous solutions having a solids content of water-soluble copolymers according to the invention of 20% by weight preferably have a turbidity of ≤700 EBC, more preferably ≤600 EBC, even more preferably ≤400 EBC and most preferably ≤200 EBC (determination according to the formazin standard in accordance with DIN 38404 at room temperature using the turbidity measuring instrument from Metrisa: model TA6FS/model 251).

The aqueous dispersions and/or the polymer powders are preferably free of emulsifiers and/or particularly free of protective colloids which are different from the water-soluble copolymers according to the invention.

The water-soluble copolymers according to the invention are preferably used as protective colloids for aqueous polymer dispersions or for powders redispersible in water.

The invention also relates to protective colloid-stabilized polymers in the form of aqueous dispersions or in powders redispersible in water, characterized in that one or more of the protective colloids are water-soluble copolymers according to the invention.

The polymers stabilized with one or more water-soluble copolymers according to the invention as protective colloids are also referred to below as base polymers.

The base polymers are preferably insoluble in water. The base polymers preferably have a solubility in water at 23° C. of preferably at most 5% by weight, more preferably at most 1% by weight. The solubility properties of polymers depend for example on their monomer composition. A person skilled in the art can provide water-insoluble or water-soluble polymers on the basis of a few orienting experiments.

The base polymers are generally different from the water-soluble copolymers according to the invention.

The base polymers are preferably based on one or more monomers from the group comprising vinyl esters of unbranched or branched carboxylic acids having 1 to 18 carbon atoms, esters of acrylic acid and methacrylic acid with unbranched or branched alcohols having 1 to 18 carbon atoms, vinyl aromatics, vinyl halides and olefins. These monomers may assume the preferred and particularly preferred embodiments specified above. The base polymers are based on the hydrophobic monomers d) mentioned above to an extent of preferably ≥50% by weight, particularly preferably ≥75% by weight and most preferably ≥90% by weight, based on the total weight of the base polymers.

Optionally, the base polymers can be based on one or more auxiliary monomers to an extent of 0.05 to 30.0% by weight, preferably 0.5 to 15% by weight, based in each case on the total weight of the base polymers. Examples of auxiliary monomers are ethylenically unsaturated mono- and dicarboxylic acids, preferably acrylic acid, methacrylic acid, fumaric acid and maleic acid; ethylenically unsaturated carboxamides and carbonitriles, preferably acrylamide and acrylonitrile; mono- and diesters of fumaric acid and maleic acid such as the diethyl and diisopropyl esters, and also maleic anhydride, ethylenically unsaturated sulfonic acids or salts thereof, preferably vinylsulfonic acid, 2-acrylamido-2-methylpropanesulfonic acid. Examples are also ethylenically unsaturated cationic monomers, especially the cationic monomers specified above. Further examples are pre-crosslinking comonomers such as polyethylenically unsaturated comonomers, for example divinyl adipate, diallyl maleate, allyl methacrylate or triallyl cyanurate, or post-crosslinking comonomers, for example acrylamidoglycolic acid (AGA), methylacrylamidoglycolic acid methyl ester (MAGME), N-methylolacrylamide (NMA), N-methylolmethacrylamide (NMMA), N-methylol allyl carbamate, alkyl ethers such as the isobutoxy ether or esters of N-methylolacrylamide, of N-methylolmethacrylamide and of N-methylol allyl carbamate. Also suitable are epoxy-functional comonomers such as glycidyl methacrylate and glycidyl acrylate. Further examples are silicon-functional monomers such as acryloxypropyltri(alkoxy)silanes and methacryloxypropyltri(alkoxy)silanes, vinyltrialkoxysilanes and vinylmethyldialkoxysilanes, wherein, for example, ethoxy and ethoxypropylene glycol ether radicals can be present as alkoxy groups, (3-glycidoxypropyl)triethoxysilane and (3-glycidoxypropyl)trimethoxysilane. Mention can also be made of monomers having hydroxyl or CO groups, for example hydroxyalkyl methacrylates and hydroxyalkyl acrylates such as hydroxyethyl, hydroxypropyl or hydroxybutyl acrylate or methacrylate and also compounds such as diacetone acrylamide and acetylacetoxyethyl acrylate or methacrylate. Further examples are also vinyl ethers such as methyl, ethyl or isobutyl vinyl ether.

Preferred auxiliary monomers for the base polymers are epoxide group-containing monomers such as glycidyl methacrylate and glycidyl acrylate, especially (3-glycidoxypropyl)triethoxysilane and (3-glycidoxypropyl)trimethoxysilane. Preferably, the base polymers are based on epoxide group-containing monomers to an extent of 0.01 to 5% by weight, particularly preferably 0.05 to 2% by weight and most preferably 0.1 to 1% by weight, based on the total weight of the base polymers. Base polymers comprising epoxide group-containing monomer units can crosslink, for example, with the water-soluble copolymers according to the invention.

In the case of water-soluble copolymers according to the invention comprising units of cationic monomers c), monomers containing acid groups such as carboxylic acids or sulfonic acids are also preferred as auxiliary monomers for the base polymers. In the case of water-soluble copolymers according to the invention comprising units of anionic monomers c), cationic monomers are also preferred as auxiliary monomers for the base polymers. Also in this embodiment, water-soluble copolymers according to the invention and the base polymers are able to engage with each other in an advantageous interaction. Examples of suitable base polymers are vinyl acetate homopolymers, copolymers of vinyl acetate with ethylene, copolymers of vinyl acetate with ethylene and one or more further vinyl esters, copolymers of vinyl acetate with ethylene and acrylic esters, copolymers of vinyl acetate with ethylene and vinyl chloride, styrene-acrylic ester copolymers, styrene-1,3-butadiene copolymers.

Preference is given to vinyl acetate homopolymers; copolymers of vinyl acetate with 1 to 40% by weight ethylene; copolymers of vinyl acetate with 1 to 40% by weight ethylene and 1 to 50% by weight of one or more further comonomers from the group of vinyl esters having 1 to 12 carbon atoms in the carboxylic acid radical such as vinyl propionate, vinyl laurate, vinyl esters of alpha-branched carboxylic acids having 5 to 13 carbon atoms such as VeoVa9R, VeoVa10R, VeoVa10R; copolymers of vinyl acetate, 1 to 40% by weight ethylene and preferably 1 to 60% by weight acrylic esters of unbranched or branched alcohols having 1 to 15 carbon atoms, especially n-butyl acrylate or 2-ethylhexyl acrylate; and copolymers having 30 to 75% by weight vinyl acetate, 1 to 30% by weight vinyl laurate or vinyl esters of an alpha-branched carboxylic acid having 5 to 13 carbon atoms, and also 1 to 30% by weight acrylic esters of unbranched or branched alcohols having 1 to 15 carbon atoms, especially n-butyl acrylate or 2-ethylhexyl acrylate, which can comprise also 1 to 40% by weight ethylene; copolymers with vinyl acetate, 1 to 40% by weight ethylene and 1 to 60% by weight vinyl chloride; wherein the polymers in each case may also comprise the auxiliary monomers specified in the amounts specified, and the figures in % by weight in each case add up to 100% by weight.

Preference is also given to (meth)acrylic ester polymers such as copolymers of n-butyl acrylate or 2-ethylhexyl acrylate or copolymers of methyl methacrylate with n-butyl acrylate and/or 2-ethylhexyl acrylate and optionally ethylene; styrene-acrylic ester copolymers with one or more monomers from the group of methyl acrylate, ethyl acrylate, propyl acrylate, n-butyl acrylate, 2-ethylhexyl acrylate; vinyl acetate-acrylic ester copolymers with one or more monomers from the group of methyl acrylate, ethyl acrylate, propyl acrylate, n-butyl acrylate, 2-ethylhexyl acrylate and optionally ethylene; styrene-1,3-butadiene copolymers; wherein the polymers may also comprise the auxiliary monomers specified in the amounts specified, and the figures in % by weight in each case add up to 100% by weight.

Aqueous dispersions of polymers stabilized with water-soluble copolymers according to the invention as protective colloid, at a solids content of 50%, may have a viscosity of preferably 10 to 10 000 mPas, particularly preferably 15 to 1000 mPas and most preferably 20 to 100 mPas. Alternatively, the aforementioned aqueous dispersions, especially for use as flocculants, at a solids content of 50%, may have a viscosity of preferably 4000 to 20,000,000 mPas, more preferably 10,000 to 5,000,000 mPas and most preferably 20,000 to 1,000,000 mPas. The viscosity is determined with a Brookfield viscometer (using spindle 1, at 25° C. and 20 rpm).

The choice of monomer or the selection of the proportions by weight of comonomers is made in this case so as to result in general in a glass transition temperature Tg of −50° C. to +50° C., preferably −30° C. to +40° C. The glass transition temperature Tg of the polymers can be determined in a known manner by differential scanning calorimetry (DSC). The Tg can also be predicted approximately by means of the Fox equation. According to Fox T. G., Bull. Am. Physics Soc. 1, 3, page 123 (1956): 1/Tg=x1/Tg1+x2/Tg2+ . . . +xn/Tgn, where xn is the mass fraction (% by weight/100) of the monomer n, and Tgn is the glass transition temperature in Kelvin of the homopolymer of the monomer n. Tg values for homopolymers are listed in Polymer Handbook 2nd Edition, J. Wiley & Sons, New York (1975).

The invention further relates to processes for producing protective colloid-stabilized polymers in the form of aqueous dispersions or powders redispersible in water by means of free-radically initiated polymerization of ethylenically unsaturated monomers by the suspension or emulsion polymerization process and optionally subsequent drying, characterized in that the polymerization is carried out in the presence of one or more water-soluble copolymers according to the invention as protective colloids.

The aqueous dispersions of the base polymers are produced by the process of aqueous suspension polymerization or preferably by the process of aqueous emulsion polymerization in the presence of preferably 0.1 to 20% by weight, more preferably 0.5 to 10% by weight and most preferably 1 to 7.0% by weight of one or more of the water-soluble copolymers according to the invention, based in each case on the total weight of the monomers for producing the base polymers.

The polymerization temperature is generally 35 to 95° C., preferably 40 to 80° C. The polymerization can be carried out in a batch process, in which all components are initially charged in the reactor, or in a metered addition process in which individual or two or more components are fed during the polymerization. Mixed types with initial charge and metered addition are preferred.

The metered additions can be carried out separately (spatially and temporally) or the components to be metered in can be metered in all or partially pre-emulsified.

The protective colloids, especially the water-soluble copolymers according to the invention, can be initially charged or metered in, or can be divided between initial charge and metered addition. The water-soluble copolymers, especially in the form of aqueous solutions, are preferably metered in.

If, for example, gaseous monomers such as vinyl chloride or ethylene are used, emulsion polymerization can also be carried out under elevated pressure. If operated under pressure, preference is given to pressures of 5 bar to 100 bar.

The water-soluble copolymers to be used as protective colloids in accordance with the invention may be used alone or in combination with emulsifiers and/or further protective colloids.

Suitable as emulsifiers are anionic, cationic or non-ionic emulsifiers. If polymerization is conducted in the presence of emulsifiers, the amount thereof is preferably up to 4% by weight, based on the total weight of monomers. Preference is given to using anionic and non-ionic emulsifiers. Examples of non-ionic emulsifiers are surfactants such as alkyl polyglycol ethers or alkylaryl polyglycol ethers having 8 to 40 alkylene oxide units. Preference is given to alkoxylated C₈- to C₁₆-alkanols which have been alkoxylated with C₂- to C₄-alkylene oxides, especially ethylene oxide and propylene oxide or mixtures thereof. Further examples are alkali metal or ammonium salts of C₈-C₁₂alkyl sulfates, of ethoxylated alkanols having a C₁₂-C₁₈-alkyl radical and a degree of EO of 3 to 30, of ethoxylated C₄-C₁₀-alkylphenols having a degree of EO of 3 to 50, of C₁₂-C₁₈-alkylsulfonic acids, of C₉-C₁₈-alkylarylsulfonic acids and of sulfonates of ethoxylated, linear or branched C₈-C₃₆-alkyl alcohols having a degree of EO of 3 to 50.

Suitable protective colloids, which optionally may be used in addition to the water-soluble copolymers according to the invention, are polyvinyl alcohols such as partially hydrolyzed polyvinyl alcohols, cellulose ethers such as methyl cellulose, methylhydroxypropyl cellulose, hydroxyethyl cellulose, carboxymethyl celluloses.

The polymerization can be initiated, for example, with the initiators or initiator combinations mentioned above, preferably in the amounts mentioned there. Optionally, the regulating substances for controlling the molecular weight mentioned above can also be used during the polymerization, preferably in the amounts specified there.

The aqueous dispersions thus obtainable have a solids content of preferably 30 to 75% by weight, more preferably 40 to 65% by weight.

The aqueous polymer dispersions of the base polymers preferably comprise 0.1 to 20% by weight, more preferably 0.5 to 10% by weight and most preferably 1 to 7.0% by weight of the water-soluble copolymers according to the invention, based on the dry weight of the aqueous polymer dispersions.

The aqueous polymer dispersions of the base polymers preferably comprise ≤20% by weight, more preferably ≤10% by weight and most preferably ≤5% by weight, even more preferably ≤0.9% by weight, based on the dry weight of the aqueous polymer dispersions, of emulsifiers and/or particularly protective colloids different from the water-soluble copolymers according to the invention. Most of all, the aqueous polymer dispersions of the base polymers do not comprise any emulsifiers and/or in particular do not comprise any protective colloids different from the water-soluble copolymers according to the invention.

To produce the base polymers in the form of powders redispersible in water stabilized with water-soluble copolymers according to the invention as a protective colloid, the aqueous dispersions of base polymers are dried, optionally after addition of protective colloids as drying aids, preferably as described further above for drying the aqueous solutions of water-soluble copolymers. Generally, the drying aid (protective colloid) is used in a total amount of 3 to 30% by weight, based on the polymeric constituents of the dispersion. Preference is given to using 5 to 20% by weight, based on the proportion of polymer.

Examples of drying aids are partially hydrolyzed polyvinyl alcohols; polyvinylpyrrolidones; polysaccharides in water-soluble form such as starches (amylose and amylopectin), celluloses and carboxymethyl, methyl, hydroxyethyl and hydroxypropyl derivatives thereof; proteins such as casein or caseinate, soya protein, gelatins; lignin sulfonates; synthetic polymers such as poly(meth)acrylic acid, copolymers of (meth)acrylates with carboxy-functional comonomer units, poly(meth)acrylamide, polyvinylsulfonic acids and water-soluble copolymers thereof; melamine formaldehyde sulfonates, naphthalene formaldehyde sulfonates, styrene-maleic acid copolymers and vinyl ether-maleic acid copolymers.

The redispersible powders according to the invention preferably comprise 0.1 to 20% by weight, more preferably 0.5 to 10% by weight and most preferably 1 to 7.0% by weight of the water-soluble copolymers according to the invention, based on the total weight of the redispersible powders.

The redispersible powders according to the invention preferably comprise 1 to 20% by weight and more preferably 2 to 15% by weight, based on the total weight of the redispersible powders, of protective colloids different from the water-soluble copolymers according to the invention.

Surprisingly, the water-soluble copolymers according to the invention act even more effectively as protective colloids than conventional protective colloids such as polyvinyl alcohols for example. This is manifested, for example, by the fact that stable dispersions are possible with higher solids content or with lower amounts of protective colloids. This applies particularly to polymers based on (meth)acrylic esters and/or aromatics such as styrene, stabilization of which with protective colloids is demanding to a particular degree.

Accordingly, the water-soluble copolymers according to the invention are suitable, for example, as protective colloid for water-insoluble polymers, particularly as protective colloid for aqueous emulsion or suspension polymerization of ethylenically unsaturated monomers or as drying aids for drying aqueous polymer dispersions.

The water-soluble copolymers can also be used as dispersants for inorganic particles such as pigments or fillers.

Advantageously, water-soluble copolymers according to the invention, when used as protective colloids for water-insoluble polymers or as dispersants, result in dispersions with surprisingly low viscosity, and so dispersions according to the invention have the desired viscosities, even at relatively high solids contents, in comparison with conventionally stabilized dispersions.

Application products with water-soluble copolymers according to the invention have advantageous performance properties, such as high water resistance for example. Construction products with water-soluble copolymers according to the invention are more stable after thermal stress or after storage in frost/thaw cycles and, after storage in water, have a lower tendency for efflorescence formation compared to corresponding construction products with conventional protective colloids. Crack formation in construction products can be counteracted using water-soluble copolymers according to the invention. The water-soluble copolymers according to the invention are also advantageously characterized by high cement compatibility and high adhesion to mineral building materials.

The polymer dispersions comprising water-soluble copolymers according to the invention or the polymer powders obtainable therefrom are also suitable as binders for coating compositions such as mortars, filling compositions, leveling compositions, plasters, building adhesives or paints, especially paints; as adhesives or binders, for example for wood, paper, textiles and nonwovens; as binders in paper production and for producing molding compositions or moldings; as binders for binding sand or dust; as additive for adhesives or coating compositions, for example for coating textiles, films, metals or particularly paper; as primers for coatings; as flocculants, thickeners, sizing for fibers, crosslinking agents or anti-dust agents.

The following examples serve to further illustrate the invention:

### Production of Water-Soluble Copolymers:

### EXAMPLE 1

A mixture of 269 g of deionized water and 0.74 g of potassium peroxodisulfate was initially charged in a reactor of 2 liter volume in a nitrogen atmosphere and the mixture was heated to 80° C. with stirring. Metered in to the reactor at this temperature were 680 g of a monomer mixture of 593.3 g of acrylamide (30% in water), 80 g of vinyl sulfonate (25% in water) and 2.0 g of Geniosil GF 56 (trade name of Wacker Chemie; vinyltriethoxysilane) over 90 minutes and an initiator solution of 62 g of potassium peroxodisulfate (3% in water) over 150 minutes. At the end of the metered addition of initiator, the mixture was post-polymerized at 80° C. for an hour. The polymer solution was then cooled to room temperature. A solution having a solids content of 20% and a viscosity of 685 s was obtained (determined with a Brookfield viscometer using spindle 2 at 25° C. and 20 rpm).

### COMPARATIVE EXAMPLE 2

Comparative example 2 was carried out identically to example 1, with the difference that the amount of Geniosil GF 56 was increased to 15% by weight (trade name of Wacker Chemie; vinyltriethoxysilane), based on the total weight of all monomers.

No aqueous polymer solution was obtained. Gelling occurred. The polymerization product was unsuitable as protective colloid.

Production of Polymer Dispersions with Water-Soluble Polymers as Protective Colloid

### EXAMPLE 3

2335 g of deionized water, 86.4 g of the polymer solution of the water-soluble copolymer of example 1 as protective colloid, 0.05 g of Dissolvine Na (ethylenediaminetetraacetic acid disodium salt), 2.5 g of FAS (aminoiminomethanesulfinic acid, 10% in water) and 24.1 g of TBHP (tert-butyl hydroperoxide, 10% in water) were initially charged in a reactor of 2 liter volume in a nitrogen atmosphere and the mixture was heated to 70° C. with stirring.

Metered in to the reactor at this temperature were a monomer mixture of 565.2 g of butyl acrylate, 100.3 g of styrene, 2.7 g of Geniosil GF 56 (trade name of Wacker Chemie; vinyltriethoxysilane) over 210 minutes and 83.6 g of FF6 (Brüggolit®FF6, trade name of Bürgemann Chemical; 12% in water) and TBHP (tert-butyl hydroperoxide, 10% in water) over 300 minutes.

At the end of the metered addition of initiator, the mixture was post-polymerized at 70° C. for an hour. The polymer solution was then cooled to room temperature.

A dispersion having a solids content of 58% and a viscosity of 1200 mPa·s was obtained (determined with a Brookfield viscometer using spindle 3 at 25° C. and 20 rpm).

### EXAMPLE 4

Example 4 was carried out identically to example 3 with the difference that no Geniosil GF 56 (vinyltriethoxysilane) was used in the polymerization for producing the polymer dispersions.

A dispersion with a solids content of 58.5% and a viscosity of 11,400 mPa·s was obtained (determined with a Brookfield viscometer using spindle 3 at 25° C. and 20 rpm). Determination of the particle size by means of a Coulter LS 230 gave a Dw value of 1380 nm.

### COMPARATIVE EXAMPLE 5

As example 4 with the difference that, as protective colloid, the water-soluble copolymer of example 1 was replaced by 119.7 g (20% in water) of polyvinyl alcohol (Mowiol 5-88, Kuraray). A dispersion with a solids content of 50.0% and a viscosity of 2980 mPa·s was obtained (determined with a Brookfield viscometer using spindle 1 at 25° C. and 20 rpm).

1.-15. (canceled)

16. A water-soluble copolymer, prepared from monomers comprising:
a) 50 to 97% by weight of one or more non-ionic, ethylenically unsaturated monomers containing amide groups,
b) 0.1 to 10% by weight of one or more ethylenically unsaturated monomers containing silane groups,
c) 1 to 30% by weight of one or more ionic, ethylenically unsaturated monomers and optionally one or more further ethylenically unsaturated monomers, wherein the weight percentages are based on the total weight of the water-soluble copolymer.

17. The water-soluble copolymer of claim 16, wherein one or more non-ionic, ethylenically unsaturated monomers containing amide groups a) are selected from the group consisting of acrylamide, methacrylamide, vinylpyrrolidone and diacetone acrylamide.

18. The water-soluble copolymer of claim 16, wherein one or more ethylenically unsaturated monomers containing silane groups b) correspond to the formula R¹SiR²₀₋₂(OR³)₁₋₃, where R¹ has the definition CH₂═CR⁴⁻(CH₂)₀₋₁ or CH₂═CR4CO₂(CH₂)₁₋₃, R² has the definition C₁- to C₃-alkyl radical, C₁- to C₃-alkoxy radical or halogen, R³ is an unbranched or branched, optionally substituted alkyl radical having 1 to 12 carbon atoms or is an acyl radical having 2 to 12 carbon atoms, where R³ is optionally interrupted by an ether group, and R⁴ is H or CH₃.

19. The water-soluble copolymer of claim 16, wherein one or more ethylenically unsaturated monomers containing silane groups b) are selected from the group consisting of γ-(meth)acryloxypropyltri(alkoxy)silanes, α-(meth)acryloxymethyltri(alkoxy)-silanes, γ-(meth)acryloxypropylmethyldi(alkoxy)silanes, vinylalkyldi(alkoxy)silanes and vinyltri(alkoxy)silanes.

20. The water-soluble copolymer of claim 16, wherein one or more ethylenically unsaturated monomers containing silane groups b) are selected from the group consisting of vinyltrimethoxysilane, vinylmethyldimethoxysilane, vinyltriethoxysilane, vinylmethyldiethoxysilane, vinyltris(1-methoxy)isopropoxysilane, methacryloxypropyltris(2-methoxyethoxy)silane, 3-methacryloxypropyltrimethoxysilane, 3-methacryloxypropylmethyldimethoxysilane, and methacryloxymethyltrimethoxysilane.

21. The water-soluble copolymer of claim 16, wherein one or more ethylenically unsaturated monomers containing silane groups b) correspond to the formula
CH₂═CR⁵—CO—NR⁶—R⁷—SiR⁸ₙ—(R⁹)₃₋ₘ, where n=0 to 4, m=0 to 2, R⁵ is H or a methyl group, R⁶ is H or is an alkyl group having 1 to 5 carbon atoms; R⁷ is an alkylene group having 1 to 5 carbon atoms or a bivalent organic group in which the carbon chain is interrupted by an O or N atom, R⁸ is an alkyl group having 1 to 5 carbon atoms, R⁹ is an alkoxy group having 1 to 40 carbon atoms, which may be substituted by further heterocycles.

22. The water-soluble copolymer of claim 16, wherein the water-soluble copolymer comprises 0.5 to 3% by weight of ethylenically unsaturated monomers containing silane groups b), based on the total weight of the water-soluble copolymer.

23. The water-soluble copolymer of claim 16, wherein one or more ionic, ethylenically unsaturated monomers c) are selected from the group consisting of acrylic acid, methacrylic acid, itaconic acid, fumaric acid, maleic acid, mono- and diesters of fumaric acid and maleic acid, vinyl sulfonic acid, 2-acrylamido-2-methylpropanesulfonic acid, styrenesulfonic acid, sulfoalkyl (meth)acrylates, sulfoalkyl itaconates,
diallyl diethylammonium chloride, (3-methacryloxy)propyltrimethylammonium chloride, (3-methacryloxy)ethyltrimethylammonium chloride, (3-methacrylamido)propyltrimethyl-ammonium chloride, trimethyl-3-(1-acrylamido-1,1-dimethylpropyl)ammonium chloride, trimethyl-3-(1-acrylamido-1,1-dimethylbutyl)ammonium chloride, dimethylacrylamidopropyl-4-trimethylammonium butenyl-2-ammonium chloride, 2-(acrylamidomethoxy)ethyltrimethyl-ammonium chloride, and diallyldimethylammonium chloride.

24. The water-soluble copolymer of claim 16, wherein the water-soluble copolymer comprises 5 to 20% by weight of ionic, ethylenically unsaturated monomers c), based on the total weight of the water-soluble copolymer.

25. A process for producing a water-soluble copolymer of claim 16, comprising polymerizing the monomers by free-radically initiated polymerization.

26. A protective colloid-stabilized polymer in the form of an aqueous dispersion or a polymer powder redispersible in water, wherein one or more protective colloids are water-soluble copolymers of claim 16.

27. The protective colloid-stabilized polymer of claim 26, wherein 0.1 to 20% by weight of water-soluble copolymers of are present, based on the dry weight of the aqueous dispersions or based on the total weight of the polymer powder redispersible in water.

28. A process for producing protective colloid-stabilized polymers in the form of aqueous dispersions or polymer powders redispersible in water by polymerizing by means of free-radically initiated polymerization of ethylenically unsaturated monomers by the suspension or emulsion polymerization process and optionally subsequent drying, wherein the polymerization is carried out in the presence of one or more water-soluble copolymers of claim 26 as protective colloids.

29. A process for dispersing inorganic particles, or water-insoluble polymers comprising dispersing the particles using a water-soluble copolymer of claim 16 as a protective colloid.

30. An adhesive molding composition; molding; binder for coating compositions or for paper production, for binding sand or dust; a primer for coatings; a flocculant, thickener, sizing for fibers, crosslinking agent, or anti-dust agent, comprising a protective colloid-stabilized polymer in the form of an aqueous dispersion or of a polymer powder redispesible in water, of claim 26.
